(19) United States
(12) Patent Application Publication
(10) Pub. No.: US 2026/0260067 A1
(43) Pub. Date: Sep. 3, 2026

(54) PROMPT-ENGINEERING FRAMEWORK FOR SYNTHETIC NAMED ENTITY RECOGNITION (NER) MODEL TRAINING

(71) Applicant: Optum, Inc., Minnetonka, MN (US)

(72) Inventors: Sanjit Singh BATRA, Millbrae, CA (US); Robert Elliott TILLMAN, Long Island, NY (US); Chufan GAO, Munster, IN (US); Zhichao YANG, Jersey City, NJ (US); Gregory D. LYNG, Minneapolis, MN (US)

(21) Appl. No.: 19/209,114

(22) Filed: May 15, 2025

Related U.S. Application Data
(60) Provisional application No. 63/765,032, filed on Feb. 28, 2025.

(51) Int. Cl. G06F 40/295; G06F 40/242

(52) U.S. Cl. CPC G06F 40/295; G06F 40/242

(57) ABSTRACT

Various embodiments of the present disclosure provide a synthetic data driven training scheme that improves the functionality of a computer in various aspects. The techniques comprise determining a labeled entity from an annotated training datapoint determined from a domain-specific training corpus. The techniques comprise determining a set of related entities from a domain-specific dictionary based on the labeled entity. The techniques comprise generating a generative prompt based on the annotated training datapoint and the set of related entities and generating, using a generative model, a set of synthetic training datapoints based on the generative prompt. The techniques comprise training the task-specific NER model using the set of synthetic training datapoints.

### CROSS REFERENCE TO RELATED APPLICATIONS

This application claims priority to U.S. Provisional Application No. 63/765,032, entitled “Synthetic Data for Biomedical Named Entity Recognition”, filed Feb. 28, 2025, the entirety of which is incorporated by reference herein for all purposes.

### BACKGROUND

In various domains, named entity recognition (NER) processes may be applied to identify and classify defined entities within content, such as text, images, audio, or the like, into predefined categories, classes, or structured representations. In specialized fields with specific entities that are important but not present outside of the field, a scarcity of data with respect to the specific entities may reduce the efficacy (e.g., in terms of scope, accuracy, recall) of NER tasks. The data scarcity phenomenon presents significant obstacles to any NER solution, including machine learning based solutions that require annotated training examples to learn patterns between defined entities and their use within an environment.

Traditionally, NER solutions rely on large volumes of annotated training data to achieve acceptable levels of accuracy. This approach has several limitations, including the time-consuming and expensive nature of annotation, especially in domains requiring subject matter expertise in which automated annotation may introduce performance deficiencies into downstream training processes. Some attempts to address these challenges have involved using rule-based systems or unsupervised learning techniques to automatically annotate training data. However, these approaches often struggle to capture the nuances, and contextual variations present in naturally occurring content, particularly in specialized domains with complex terminology. In some approaches, the transfer learning and pre-trained language models are applied to improve NER performance in low-resource scenarios. While these methods have shown promise, they require a non-trivial amount of in-domain annotated data and are prone to hallucinations and other performance deviations that introduce inaccuracies disruptive a downstream training process.

### BRIEF DESCRIPTION OF THE DRAWINGS

FIG. 1 is a block diagram of an example architecture in accordance with some embodiments of the present disclosure.

FIG. 2 is a block diagram of an example predictive data analysis computing entity in accordance with some embodiments of the present disclosure.

FIG. 3 is a block diagram of an example client computing entity in accordance with some embodiments of the present disclosure.

FIG. 4 is a dataflow diagram of a training technique for an NER model in accordance with some embodiments of the present disclosure.

FIG. 5 is a dataflow diagram of a synthetic training framework in accordance with some embodiments of the present disclosure.

FIG. 6 is an operational example of a domain-specific dictionary in accordance with some embodiments of the present disclosure.

FIG. 7 is an operational example of a generative prompt for a synthetic training datapoint in accordance with some embodiments of the present disclosure.

FIG. 8 is a flowchart diagram of machine learning model training process in accordance with some embodiments of the present disclosure.

### DETAILED DESCRIPTION

Various embodiments of the present disclosure provide synthetic data driven training techniques that improve the functionality of a computer in various domains, including with respect to NER model training tasks. To do so, some embodiments of the present disclosure provide a synthetic training framework that combines prompt engineering with domain-specific knowledge bases to introduce targeted variations within an annotated dataset. For example, to overcome performance deficiencies associated with traditional training techniques that are prone to hallucinations and other performance deficiencies, the synthetic training framework provides a two-stage processing pipeline that sequentially, and/or in parallel, extracts a set of counteracting attributes from an annotated training datapoint that are collectively configured to mimic the annotated training datapoint, while introducing variations absent from the annotated training datapoint. At a first processing pipeline, for example, the synthetic training framework may leverage a generative prompting scheme to extract datapoint attributes in accordance with a set of synthetic data constraints configured to align a synthetic training datapoint with an original dataset. The datapoint attributes may be balanced using a second processing pipeline, where the synthetic training framework leverages a domain-specific dictionary to generate a set of related entities for one or more labeled entities within the annotated training datapoint. The synthetic training framework may synthetize the outputs of both processing pipelines into a generative prompt that may control a synthetic generation process of a generative model. By synthesizing the datapoint attributes with the set of related entities, the generative prompt may enable the generation of synthetic data that mimics an original dataset, while introducing small, targeted variations that enhance the diversity of the original dataset. In this way, the synthetic training framework may expand the diversity of synthetic training data while maintaining domain relevance. By doing so, the synthetic training framework may improve the generalization capabilities of downstream task-specific NER models, enabling them to handle a broader range of entity variations without compromising accuracy. Ultimately, by integrating the synthetic training framework within a training scheme for an NER model, the techniques of the present disclosure may improve the performance of NER models, in terms of accuracy (e.g., F1), precision, and recall, at less computation cost compared to traditional approaches.

More particularly, some embodiments of the present disclosure provide an improved feature extraction technique for augmenting a generative model prompt to improve synthetic data quality. The improvements to synthetic data quality, for example, may be provided by a first processing pipeline of the synthetic training framework. To do so, the first processing pipeline may implement a targeted prompting scheme configured to sequentially, and/or in parallel, extract a set of datapoint attributes in accordance with a set of synthetic data constraints. Unlike traditional approaches to synthetic data generation, the set of synthetic data constraints may preserve domain-specific characteristics of an original dataset in a manner that reduces performance deviations, while allowing for variations to the underlying data. For example, the synthetic data constraints may comprise length constraints, context constraints, topic constraints, style constraints, distribution constraints, structural constraints, among others that systematically define domain-specific characteristics common to a subset of annotated training datapoints within a domain-specific training corpus. Up to each of the constraints may target a quality measure for improving the quality and relevance of synthetic data. For example, topic constraints may improve the relevancy of the synthetic data, context constraints may improve the applicability of the synthetic data, structural and length constraints may improve the realism of the synthetic data, and label distribution constraints may reduce bias. In this manner, through a set specifically defined constraints, the first processing pipeline of the synthetic training framework may improve data quality in a synthetic data generation process, which may, in turn, improve the performance of downstream machine leaning models as well as the training techniques used thereon.

In addition, or alternatively, some embodiments of the present disclosure provide improved augmentation techniques for introducing targeted variations to synthetic data without comprising data quality. The improved augmentation techniques, for example, may be provided by a second processing pipeline of the synthetic training framework. To do so, the second processing pipeline may integrate a domain-specific dictionary into a synthetic data generation process to enable targeted variations that semantically deviate from an original datapoint within a bounded deviation space. The bounded deviation space, for example, may be defined by a set of related entities extracted from the domain-specific dictionary with respect to a particular label within an annotated training datapoint. To enable sematic deviations within the bounded deviation space, the set of related entities may be confined to semantically adjacent entities (e.g., similar semantic meaning) and/or sub-entities (e.g., more specific semantic meaning encapsulated by the entity) to a labeled entity within an annotated training datapoint. This, in turn, enables controlled and targeted variations within synthetic training datapoints that may improve the diversity of a training dataset without introducing hallucinations, or other data inconsistencies that may reduce, rather than improve, the inference capabilities of downstream NER models.

Some embodiments of the present disclosure are integrated within a synthetic data driven training scheme to address technical challenges related to NER tasks in specialized domains, particularly in contexts where annotated training data is limited. To do so, some embodiments of the present disclosure may introduce new techniques for synthetic data augmentation that may be integrated within a training scheme to improve the downstream performance of a trained NER model. The techniques, for example, may leverage the capabilities of a generative model, such as large language models (LLMs), and domain-specific knowledge bases (e.g., domain-specific dictionaries) to generate high-quality synthetic training data, reducing the reliance on extensive manual annotation and improving the adaptability of NER systems to evolving terminology in specialized domains. For example, as described herein, traditional NER techniques may struggle with limited annotated data in specialized domains, leading to poor model performance and reduced generalizability to unseen data. By utilizing a generative model in conjunction with domain-specific attributes and related entities, embodiments of the present disclosure may produce synthetic training datapoints that closely mimic the characteristics of real-world data, while introducing slight variations to improve data diversity. This enables the creation of improved large-scale and diverse training datasets during a training process, which may reduce the time and resources required for model development, while improving model performance.

Ultimately, by automating the process of synthetic data generation and incorporating domain-specific knowledge, the embodiments of the present disclosure enable the creation and maintenance of robust NER models for specialized domains. This approach addresses the challenges of data scarcity and domain specificity, allowing for the development of more accurate and versatile NER systems. As a result, the embodiments of the present disclosure facilitate improved information extraction and analysis capabilities across various technical fields, enhancing the overall efficiency and effectiveness of domain-specific natural language processing tasks.

Examples of technologically advantageous embodiments of the present disclosure comprise improved data generation and model training techniques among other aspects of the present disclosure, that generate synthetic data capable of both mimicking and introducing slight variations to annotated data that improve data quality and data diversity in a synthetic data driven training scheme. Other technical improvements and advantages may be realized by one of ordinary skill in the art.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

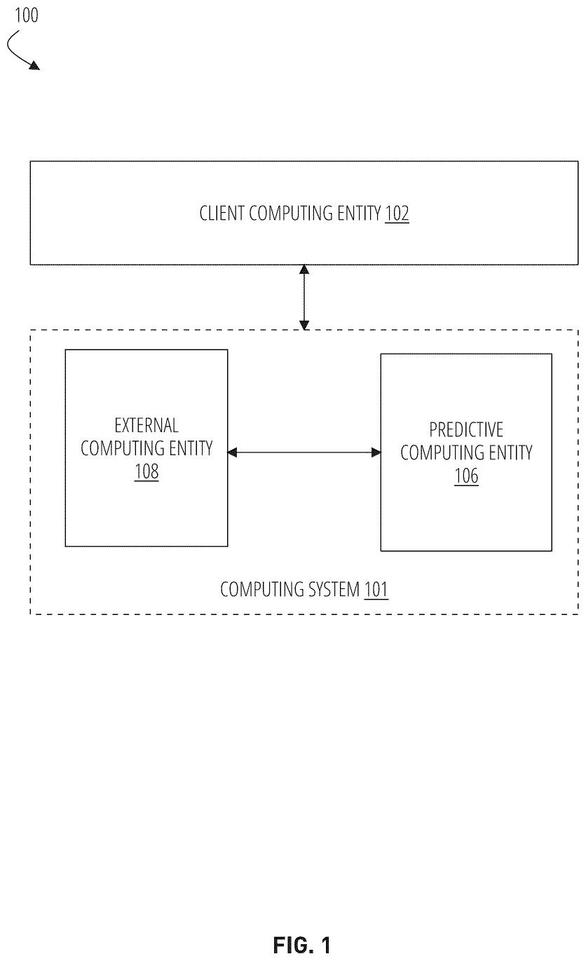

FIG. 1 is a block diagram of an example architecture 100 in accordance with some embodiments of the present disclosure. The architecture 100 comprises a computing system 101 configured to receive a request, such as a model training request, and/or the like, from client computing entities 102, process the request, and provide a response, such as synthetic data, to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate candidate outputs, candidate output scores, and/or other machine learned outputs. The models may be adapted to a training pipeline that may collectively process a training request to train a model through a sequential data augmentation and training scheme that addresses data limitations without introducing inaccuracies through hallucinations and other data augmentation complications.

In some embodiments, the computing system 101 may communicate with at least one of the client computing entities 102 using one or more communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., generative techniques, training techniques) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as training corpus, domain-specific dictionary, and/or the like, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

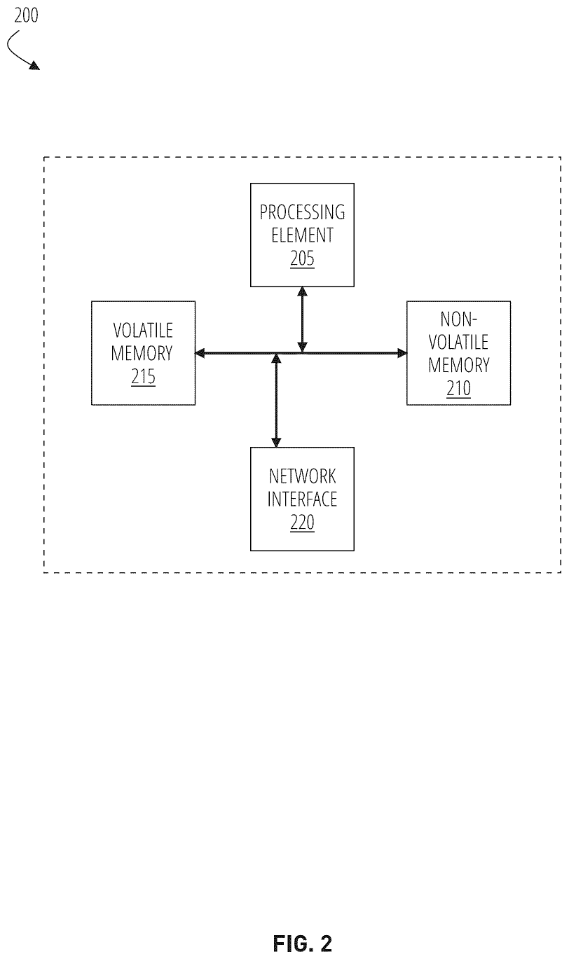

FIG. 2 is a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably), volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilize quantum bits, or qubits, which may exist in multiple states simultaneously through a property called superposition. Unlike classical bits that may only be in a state of 0 or 1, qubits may represent both states at once, allowing for exponentially larger information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

In some embodiments, one or more embodiments of the present disclosure may be implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computer entity 200 may be specialized for machine learning task. By way of example, large language models (LLMs) and other transformer networks may be specially designed for operation within a quantum environment by replacing weight matrices in self-attention and/or multi-layer perceptron layers of such models with one or more combinations of two variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

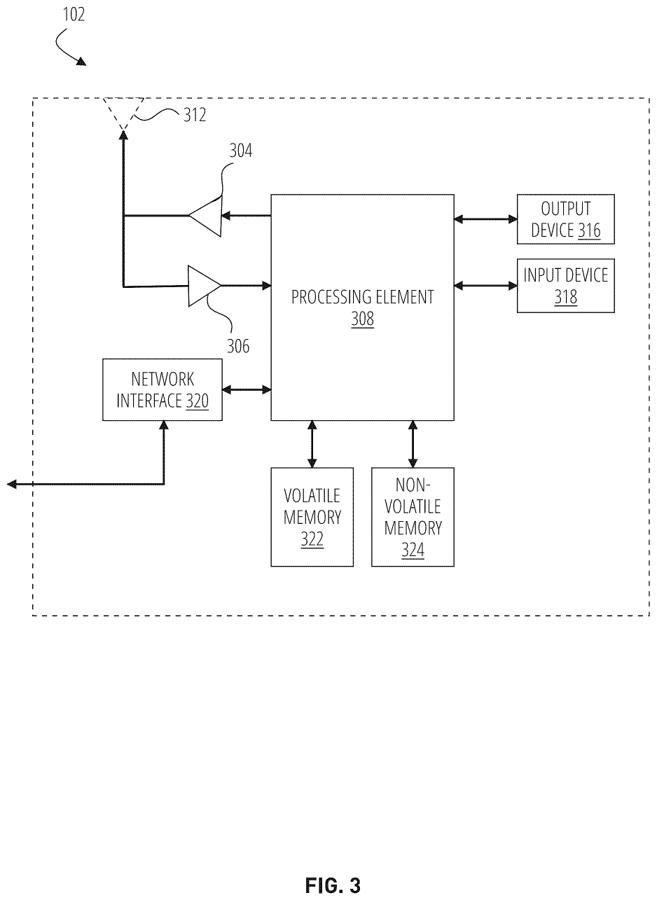

FIG. 3 is a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

As indicated, various embodiments of the present disclosure make important technical contributions to computer functionality, including machine model training and inference. In particular, systems and methods are disclosed herein that implement prompt engineering and training techniques to improve synthetic data generation and machine learning model training in various domains. By doing so, the prompt engineering and training techniques of the present disclosure enable improved machine learning processes that, when executed on a computer, improves the performance of training operations, as well as the accuracy, precision, and/or recall of downstream predictive inferences. This, in turn, may improve the functionality of a computer with respect to various computing tasks, including data security, network communication, natural language process, query processing, among others.

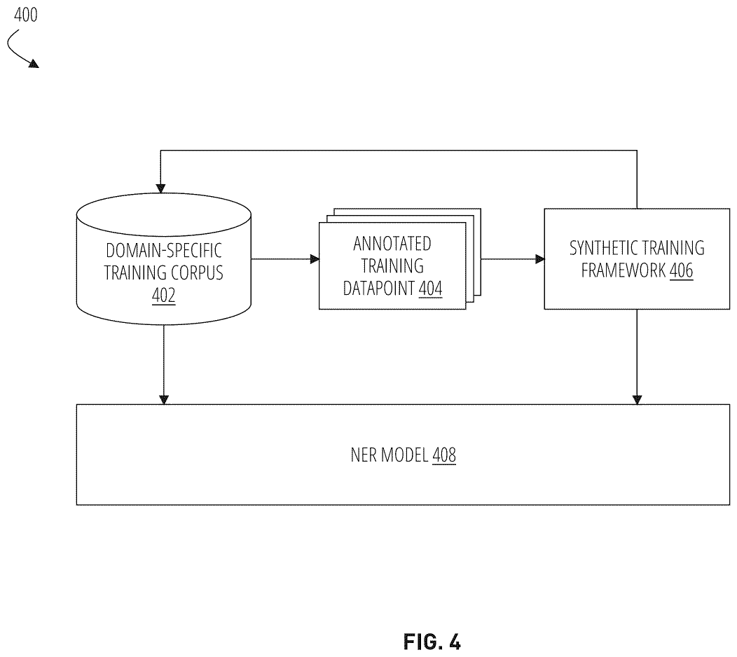

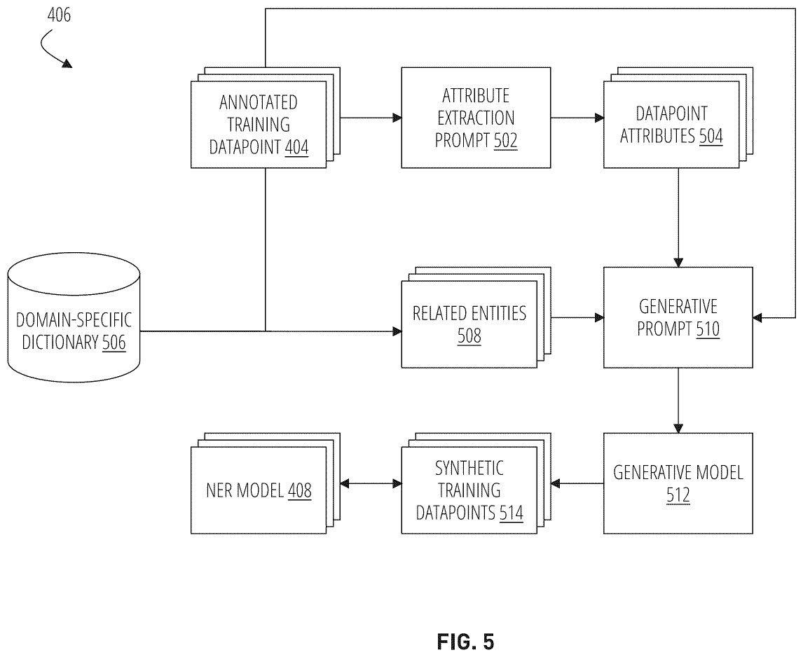

FIG. 4 is a dataflow diagram of a training technique 400 for an NER model in accordance with some embodiments of the present disclosure. A computing system, such as the computing system 101, may execute the training technique 400 to improve the accuracy, coverage, and scope of NER models 408 with respect to a particular domain. To do so, the computing system 101, and/or another system, may augment the annotated training datapoints 404 from a domain-specific training corpus 402 with highly realistic (e.g., accurate) synthetic training datapoints through a synthetic training framework 406. As described in further detail with reference to FIG. 5, the synthetic training framework 406 may constrain the generation of synthetic training datapoints using a set of synthetic data constraints and/or a labeled entity replacement scheme that are designed to reduce hallucinations and enforce similarities between the annotated training datapoints 404 and synthetic training datapoints, while enhancing the diversity of the domain-specific training corpus 402. By doing so, the training technique 400 may address data and annotation deficiencies, in any domain, using an automated generative pipeline without introducing inaccuracies into a training dataset. This, in turn, enables the computing system 101 to facilitate of the generation and training of improved NER models that outperform traditional models in terms of accuracy (e.g., F1), precision, and recall.

In some embodiments, a computing system 101 determines one or more annotated training datapoints 404 from a domain-specific training corpus 402. The domain-specific training corpus 402, for example, may be annotated for a task-specific NER model 408. In some examples, the annotated training datapoints 404 are a subset of annotated training datapoints determined from the domain-specific training corpus 402. For instance, the subset of annotated training datapoints 404 may be determined based on a relative label distribution between each annotated training datapoint within the subset of annotated training datapoints 404 and the domain-specific training corpus 402.

In some embodiments, the domain-specific training corpus 402 comprises a set of annotated training datapoints for a particular domain. A domain-specific training corpus 402, for example, may comprise a collection of sentences, such as clinical notes for a clinical domain, or any other set of inputs (e.g., images, audio files) with corresponding labels (e.g., annotations) that are specific to a particular field or area of expertise. The domain-specific training corpus 402 may be stored in a computer-readable format, such as a structured database, a set of text files, a set of audio or video snippets, a set of images, and/or the like. The domain-specific training corpus 402 may be implemented using various data storage technologies, including relational databases, document-oriented databases, distributed file systems, graph databases, and/or the like,

In the context of NER tasks, the domain-specific training corpus 402 may comprise knowledge foundation for training task-specific NER models 408. Up to each datapoint in the domain-specific training corpus 402, for example, may be annotated with entity labels that are relevant to the domain, allowing downstream NER models 408 to learn the patterns and relationships between datapoints, such as words, image bounding boxes, audio snippets, and their corresponding entity types. For example, in a clinical domain, the domain-specific training corpus 402 may comprise a set of sentences from medical literature or clinical notes with annotations for entities, such as diseases, medications, anatomical structures, and/or the like. As another example, in a security scanning domain, the domain-specific training corpus 402 may comprise a set of images from banned substance listings, a set of sentences from security risk publications, and/or the like with annotations for entities, such as security risks, weapons, harmful substances, and/or the like.

In some embodiments, a domain-specific training corpus 402 is used to train, evaluate, and/or test a NER model 408 to finetune the model for a particular domain, and/or a task (e.g., a disease classification task, a risk detection task) therein. The performance of any NER model 408 trained using the domain-specific training corpus 402 may depend on the diversity of the annotated training datapoints 404 within the domain-specific training corpus 402. This leads to performance deficiency, in terms of accuracy, precision, and/or recall, for NER models 408 in domains with extensive entity sets that are incompletely modeled within the domain-specific training corpus 402. To address this deficiency, a synthetic training framework 406 may be applied to augment the domain-specific training corpus 402 with synthetic training datapoints that expand the available training data and improve model robustness.

To do so, the synthetic training framework 406, which is detailed further with reference to FIG. 5, may determine a subset of annotated training datapoints 404 from the domain-specific training corpus 402 that may serve as seed samples for a synthetic data generation process. For instance, an annotated training datapoint of the subset of annotated training datapoints 404 may comprise a seed datapoint from the domain-specific training corpus 402 that is annotated with one or more labeled entities specific to a domain. An annotated training datapoint 404, for example, may comprise a piece of content along with one or more labels (e.g., annotations) that identify and classify named entities within the content. By way of example, the annotated training datapoint 404 may comprise a piece of text, such as a sentence, paragraph, or phrase, with one or more labels (e.g., annotations) that identify and classify named entities within the text; an image, such as a single frame or multi-frame image, with one or more labels (e.g., annotations) that identify and classify named entities within the imagery; an audio file with one or more labels (e.g., annotations) that identify and classify named entities within the audio, and/or the like.

In some embodiments, the labels of an annotated training datapoint 404 are represented as a set of labels or tags associated with specific portions (e.g., text spans, image coordinates, audio ranges) of the annotated training datapoint. Up to each label may be stored in a structured format, such as JSON, XML, and/or the like. In some examples, the annotation of an annotated training datapoint 404 may be performed manually by domain experts or through semi-automated methods using annotation tools, pre-existing knowledge bases, and/or the like.

In some examples, an annotated training datapoint 404 may be used as input for training machine learning models, such as the NER models 408 of the present disclosure, by providing examples entities specific to a particular domain. During the training process, for example, a model may be trained (e.g., through back propagation using gradient descent to optimize performance with respect to a reconstruction or any other loss) to recognize patterns and contextual cues that indicate the presence and/or type of labeled entities annotated within an annotated training datapoint 404. In this manner, a quality and diversity of annotated training datapoints 404 may directly impact the performance and generalization capabilities of the resulting model.

In the context of synthetic data generation, as described in this disclosure, annotated training datapoints 404 may provide seed examples for creating additional, synthetic training data to improve the quality and diversity of annotated training datapoints 404 within the domain-specific training corpus 402. By analyzing the characteristics of these datapoints, including their structure, entity distribution, and contextual features, the synthetic training framework 406 may produce new datapoints that maintain the essential properties (e.g., maintain quality) of the original annotated data while introducing variations that improve the diversity of the annotated data.

In some embodiments, the computing system 101 determines the subset of annotated training datapoints 404 from the domain-specific training corpus 402 based on relative label distribution of the domain-specific training corpus 402. The relative label distribution, for example, may represent a number of labels within up to each annotated training datapoint 404 relative to a distribution of labels within domain-specific training corpus 402. The relative label distribution, for example, may provide a measure of how labeled entities of a particular datapoint compare to the overall distribution of annotations across the entire training corpus. By way of example, a relative label distribution may comprise a ratio, percentage, probabilistic value, and/or the like that measures a number of labels in a specific annotated training datapoint 404 compared to an average number of labels per datapoint in the entire domain-specific training corpus 402. The result may be stored as a floating-point value, as a discrete category (e.g., “high”, “medium”, “low”), and/or the like, depending on the implementation requirements. In addition, or alternatively, the relative label distribution may comprise a number of labeled entities within the annotated training datapoint 404.

The relative label distribution may be used as a criterion for selecting a subset of annotated training datapoints 404 from the domain-specific training corpus 402. For example, the subset of annotated training datapoint 404 may comprise a subset of datapoints associated with relative label distributions that meet or exceed a distribution threshold (e.g., the top 10%, 10 labeled entities). By considering the relative label distribution, the selection process may ensure that the chosen datapoints are representative of the overall corpus in terms of entity density and diversity. This selection strategy helps maintain the balance of entity types and frequencies when generating synthetic data, preventing biases that could arise from overrepresenting certain label distributions.

In some embodiments, a computing system 101 the computing system 101 trains the task-specific NER model 408 using the domain-specific training corpus 402 and/or a set of synthetic training datapoints generated through the synthetic training framework 406. In some embodiments, the NER model 408 comprises a machine learning model, such as a transformer, that is trained to identify and/or classify portions of an input according to a domain-specific entities, such as those defined within a domain-specific dictionary. The NER model 408, for example, may be designed to perform entity recognition tasks within a particular domain and/or for a specific application by incorporating domain-specific knowledge with respect to the particular domain or application. By way of example, the NER model 408 may comprise a specialized model that may by finetuned from a generic model to improve its performance with respect to a particular domain or application.

In some examples, the NER model 408 may be implemented as a deep learning architecture, such as a transformer model (e.g., Bidirectional Encoder Representations from Transformers (BERT)), and/or the like. The NER model 408, for example, may comprise one or more self-attention mechanisms and/or one or more neural network layers configured to process and understand the context of input content based on parameters tuned according to a particular domain-specific dataset. The model's parameters, for example, may be stored in memory and/or updated during the training process using optimization algorithms, such as stochastic gradient descent, and/or the like.

In some embodiments, the NER model 408 may be trained using a combination of real annotated data and/or synthetically generated datapoints to enable the NER model 408 to learn from a larger, more diverse dataset than would be available through other annotation schemes. This approach helps to improve the model's generalization capabilities and its ability to handle rare or novel entity types within the domain. During inference, the NER model 408 may receive in raw inputs (e.g., text, imagery, audio), tokenize the inputs, and assign entity labels to relevant tokens or spans of tokens within the input. The output of the NER model 408 may comprise the original input with labeled entities. The labeled entities may, in turn, be used for downstream tasks, such as information extraction, question answering, data analytics, and/or the like, within the specific domain.

FIG. 5 is a dataflow diagram of a synthetic training framework 406 in accordance with some embodiments of the present disclosure. A computing system, such as the computing system 101, may execute the synthetic training framework 406 to generate synthetic training datapoints 514 for augmenting annotated training datapoints 404 of a domain-specific training corpus during a synthetic data driven training technique. To do so, the computing system 101, and/or another system, may determine a set of annotated training datapoints 404 from the domain-specific training corpus as a set of seed datapoints for a generative process. The synthetic training framework 406 may extract attributes from the set of annotated training datapoints 404 using two (e.g., parallel or sequential) processing pipelines that process the annotated training datapoint 404 both collectively and individually to capture insights that may constrain a generative model 512. The first processing pipeline, for example, may comprise a collective processing pipeline in which the annotated training datapoints 404 are collectively processed to extract a set of datapoint attributes 504 that represent one or more different, defined constraints shared by the annotated training datapoints 404. The second processing pipeline may extract individual labeled entities from each of the annotated training datapoints 404 to provide a basis on which to query related entities 508 from a domain-specific dictionary 506. The two processing pipelines may be followed by a generative process that combines the insights from each pipeline into a generative prompt 510 for generating synthetic data from one of the annotated training datapoints 404. The generative process may be performed for up to each of the annotated training datapoints 404 to generate a set of synthetic training datapoints 514 that capture representative features from the annotated training datapoints 404 (e.g., through the incorporation of the datapoint attributes 504), while introducing diversity not represented by the annotated training datapoints 404 (e.g., through the incorporation of the related entities 508). This, in turn, allows for the generation of improved training data that may be applied to improve the accuracy and applicability of NER models with respect to any domain, including domains that traditionally lack the robust annotated datasets typically required for such models.

In some embodiments, at the first processing pipeline, the computing system 101 generates an attribute extraction prompt 502 based on a set of synthetic data constraints and/or a subset of annotated training datapoints 404 from the domain-specific training corpus. In some examples, the attribute extraction prompt 502 may comprise a set of extraction instructions for up to each of the set of synthetic data constraints.

In some embodiments, the attribute extraction prompt 502 comprises a generative model prompt with extraction instructions for at least one of a set of synthetic data constraints. An attribute extraction prompt 502, for example, may comprise is a structured input provided to a generative model 512 to guide the extraction of specific attributes and/or features from a specified content. In some examples, the attribute extraction prompt 502 may comprise a string of text that comprise natural language instructions (e.g., extraction instructions), one or more formatting and/or templating elements, for instructing a generative model 512 to output at least one of the datapoint attributes 504 for one or more annotated training datapoints 404. The generative prompt 510, for example, may be designed to be processed by a generative model 512, such as a large language model, capable of understanding and executing the extraction instructions. In some examples, a template of the generative prompt 510 may be stored as a text file, a string variable, and/or the like. During an iteration of the synthetic training framework 406, the template may be retrieved from memory, updated with the annotated training datapoint 404 (and/or a reference to the annotated training datapoint 404), and provided to a generative model 512 to receive at least one of the datapoint attributes 504.

In some embodiments, the generative model 512 comprises a generative machine learning model, such as a large language model (LLM), and/or the like. A generative model 512, for example, may comprise an artificial intelligence system designed to generate data responsive to a model prompt, such as the attribute extraction prompt 502 (and/or the generative prompt 510 described herein). In some examples, the generative model 512 may comprise text-based, image-based model, audio-based model, multi-modal model, and./or the like.

Regardless of the data type, a generative models may comprise a type of deep neural network, such as transformers, recurrent neural networks (RNNs), generative adversarial networks (GANs), convolutional neural networks (CNNs), and/or the like. These models may be trained on large datasets using techniques, such as unsupervised or semi-supervised learning, allowing them to capture complex patterns and relationships within the training data. A generative model 512, for example, may be represented as large tensors of floating-point numbers, which encode the learned parameters of the neural network. During training, these parameters may be updated using optimization algorithms, such as stochastic gradient descent, to minimize a loss function (e.g., reconstruction loss) that measures the difference between the generated output and the desired output. In the context of the synthetic training framework 406, generative model 512 may comprise a data extraction model (e.g., configured to process an attribute extraction prompt 502), a synthetic data generation model (e.g., configured to process a generative prompt 510), and/or a generalized model configured to produce different outputs through various instruction finetuning techniques of the present disclosure.

By way of example, the attribute extraction prompt 502 may comprise an attribute-specific prompt that comprise extraction instructions for one or more of the set of synthetic data constraints that may be processed by the generative model 512 to produce at least one datapoint attribute. In such as case, the datapoint attributes 504 may be generated through a multi-prompting sequence in which a set of attribute extraction prompts 502 may be sequentially (and/or in parallel) provided to the generative model 512. In addition, or alternatively, the attribute extraction prompt 502 may comprise extraction instructions for up to each of the set of synthetic data constraints to generate the datapoint attributes 504 through single prompt.

In some embodiments, the extraction instructions comprise one or more instructions of an attribute extraction prompt 502 that are specific to a particular synthetic data constraint. An extraction instruction, for example, may comprise a specific directive within the attribute extraction prompt 502 that guides the generative model 512 in identifying and/or extracting a particular type of information or attribute from the input content. In some examples, the extraction instruction may comprise a natural language statement, question, and/or the like that is part of the larger attribute extraction prompt 502. The extraction instructions, for example, may be designed to be interpretable by advanced language models and may include specific keywords, formatting, and/or examples to clarify the desired extraction task. The extraction instructions may be stored as separate string variables, as elements within a structured prompt template, and/or the like.

In some embodiments, a synthetic data constraint is one of a set of constraints used to constrain a synthetic data generation process. The synthetic data constraints, for example, may define attributes that capture features of the annotated training datapoints 404, as a whole, ensuring that the generated synthetic data maintains the characteristics and quality of the original dataset. A synthetic data constraint may be implemented as a set of parameters, rules, and/or the like. The constraints, for example, may comprise constraints that may be represented as numerical ranges, categorical variables, complex data structures, and/or the like. For example, a length constraint may be stored as a minimum and/or maximum observed word count within the annotated training datapoints 404, while a topic constraint may be represented as a list of relevant keywords or a probability distribution over possible topics.

In the context of synthetic training framework 406, the synthetic data constraints may be used to guide the generation of synthetic training datapoints 514. By applying these constraints, the computing system 101 may ensure that the generated data maintains the essential properties of the original domain-specific corpus, such as structure, entity distribution, and contextual relevance, among others described herein. By doing so, the synthetic data constraints may enable the creation of more realistic and diverse synthetic datasets that may improve the training and performance of NER models 408.

In some embodiments, a synthetic data constraint comprises a data length constraint. A data length constraint may comprise one of the synthetic data constraints that captures a representative size, size range, or the like, of the annotated training datapoints 404. A data length constraint, for example, may define an acceptable length or size of synthetic training datapoints 514 to be generated, ensuring that they are consistent with the characteristics of the original dataset. A data length constraint may be implemented as a numerical parameter or range. By way of example, the data length constraint may be stored as an integer value representing a target length, as a tuple or object containing minimum and maximum values to define an acceptable range, and/or the like. In addition, or alternatively, the data length constraint may be represented as a probability distribution that reflects the length variability observed in the original dataset.

In some embodiments, a synthetic data constraint comprises a topic constraint. A topic constraint may comprise one of the synthetic data constraints that captures a representative subject matter of the annotated training datapoints 404. A topic constraint, for example, may ensure that the generated synthetic training datapoints 514 remain relevant to the subject matter of the original dataset, maintaining thematic consistency across the synthetic corpus. The topic constraint, for example, may comprise one or more of a set of keywords, themes, and/or semantic categories that define the relevant subject matter for the domain. In some examples, the constraint may be represented as a list of topic labels, a probability distribution over possible topics, a topic vector in a high-dimensional space, and/or the like. By enforcing topic relevance, the computing system 101 may ensure that the synthetic datapoints contain appropriate vocabulary, concepts, and/or entity types that are characteristic of the domain. This constraint helps maintain the semantic coherence of the generated data, making it more effective for training domain-specific NER models 408.

In some embodiments, the tone constraint is one of the synthetic data constraints that captures a representative writing style of the annotated training datapoint 404. A tone constraint, for example, may ensure that the synthetic training datapoints 514 maintains a consistent writing style, or tone, that is characteristic of the original dataset. In some examples, the tone constraint may be implemented as a set of stylistic parameters and/or a model of language characteristics that define an observed writing style. This may include features such as formality level, sentiment, technical complexity, specific linguistic patterns, and/or the like. In some examples, the constraint may be represented as a set of rules, a statistical model of language features, embeddings that capture stylistic attributes, and/or the like. By doing so, the tone constraint may ensure that the synthetic training datapoints 514 not only contain relevant content but also reflect the appropriate tone and language conventions of the domain. This enhances the realism of the synthetic training datapoints 514 and helps improve a downstream model's ability to generalize to new, unseen text within the domain.

In some embodiments, a synthetic data constraint comprises a domain constraint. A domain constraint may comprise one of the synthetic data constraints that captures a representative context of the set of datapoints. A domain constraint may ensure that synthetic training datapoints 514 remain applicable to a particular domain or context, maintaining the relevance and specificity of the data for the intended application. In some examples, the domain constraint may comprise a set of rules, knowledge bases, and/or models that define the characteristics and boundaries of the specific domain. This may include domain-specific terminology, entity types, relationships between entities, and common patterns or structures found in the domain. The constraint may be represented using ontologies, knowledge graphs, or domain-specific language models that capture the nuances of the particular field. By doing so, the domain constraint may be used to guide the generative model 512 in producing text that accurately reflects the context and conventions of the specific domain. This may ensure that the synthetic training datapoints 514 contain appropriate entities, relationships, and scenarios that are realistic and relevant to the domain.

In some embodiments, a synthetic data constraint comprises a structural constraint. A structural constraint may comprise one of the synthetic data constraints that captures a representative structure of annotated training datapoints 404. A structural constraint, for example, may ensure that the generated synthetic data maintains consistent formatting, organization, and/or compositional patterns that are characteristic of the original dataset. In some examples, structural constraint may comprise as a set of rules, templates, and/or the like that define an expected structure of the synthetic training datapoints 514 based on observed structural patterns within the annotated training datapoints 404. This may include specifications for sentence or paragraph structure, document layout, the arrangement of different components within a synthetic training datapoints 514, and/or the like. The constraint may be represented using formal grammars, regular expressions, or more complex structural models that capture the hierarchical or sequential nature of the data. By doing so, the structural constraint may guide the generation of synthetic training datapoints 514 that follow the formatting and organizational patterns of a domain. For example, the structural constraint may enforce the use of specific sections (e.g., patient history, diagnosis, treatment plan in a clinical use case) in a consistent order. In this way, the structural constraint may preserve the organizational consistency of the synthetic training datapoints 514 to improve data organizational consistency across annotated training datapoints 404 and the synthetic training datapoints 514.

In some embodiments, a synthetic data constraint comprises a label distribution constraint. The label distribution constraint may comprise one of the synthetic data constraints that captures a representative label distribution of the annotated training datapoints 404. A label distribution constraint, for example, may ensure that the synthetic training datapoints 514 maintains a similar distribution of labeled entities as observed in the original dataset, preserving the balance and frequency of different entity types. By maintaining a consistent label distribution, the synthetic training datapoints 514 may provide a more accurate representation of the entity relationships and frequencies that a NER model 408 would encounter in real-world data. This helps prevent biases that could arise from over- or under-representing certain entity types during training. Alternative applications of label distribution constraints may comprise generating balanced datasets for machine learning tasks in various domains, simulating realistic data scenarios for system testing, creating synthetic populations with specific attribute distributions for demographic studies or market research, among others.

The computing system 101 generates, using a generative model 512, a datapoint attribute 504 for up to each of the set of synthetic data constraints based on the attribute extraction prompt 502. In some examples, the computing system 101 generates up to a set of datapoint attributes 504 respectively corresponding to up to the set of synthetic data constraints based on the attribute extraction prompt 502 (and/or a sequence or set of attribute extraction prompts 502).

In some embodiments, a datapoint attribute of the set of datapoint attributes 504 comprises an extracted data feature that corresponds to one of a set of synthetic data constraints. A datapoint attribute, for example, may represent a specific characteristic or property of the annotated training datapoints 404 that aligns with a particular synthetic data constraint, capturing shared features that define the nature and quality of the data. In some examples, a datapoint attribute may be implemented as a structured representation of a specific feature extracted from the original data. For example, the datapoint attribute may comprise a numerical value, a categorical label, a vector of features, and/or the like, depending on the synthetic data constraint. Regardless of form, the datapoint attributes 504 may be leveraged to inform and/or guide the creation of synthetic training datapoints 514 that maintain the characteristics of the annotated training datapoint 404. Up to each attribute, for example, may correspond to a specific synthetic data constraint, such as length, topic, style, context, structure, or label distribution, and/or the like. By extracting and utilizing these attributes, the computing system 101 may ensure that the synthetic training datapoints 514 closely mimics the properties of the annotated training datapoint 404 across multiple dimensions. By doing so, the datapoint attributes 504 may improve the quality and relevance of the synthetic training datapoints 514 for training NER models 408 and other machine learning tasks.

In some examples, a datapoint attribute of a set of datapoint attributes 504 may comprise a length attribute that corresponds to a data length constraint that controls a length of a synthetic training datapoint of the set of synthetic training datapoints 514. The length attribute, for example, may comprise an extracted data feature that corresponds to data length constraint that controls a length of a synthetic training datapoint of the set of synthetic training datapoints. For instance, a length attribute may capture a size, size range, and/or the like of the annotated training datapoints 404 in terms of word count, character count, bounding box area, audio range, and/or other units depending on the data type.

In some examples, a datapoint attribute of a set of datapoint attributes 504 may comprise a topic attribute that corresponds to a topic constraint that controls a subject category of the synthetic training datapoints 514. The topic attribute, for example, may comprise an extracted data feature that corresponds to a topic constraint that controls a subject category of the synthetic training datapoints 514. A topic attribute, for example, may capture a thematic content or subject matter of the annotated training datapoints 404, representing the primary concepts or themes discussed within them. In some examples, the topic attribute may comprise one or more keywords, probability distributions over possible topics, a vector representations in a semantic space, and/or the like.

In some examples, a datapoint attribute of a set of datapoint attributes 504 may comprise a style attribute that corresponds to a tone constraint that controls a tone of the synthetic training datapoints 514. The style attribute, for example, comprises an extracted data feature that corresponds to a tone constraint that controls a tone of the synthetic training datapoints 514. For example, a style attribute may capture a writing style, tone, or linguistic characteristics of the annotated training datapoints 404, representing the manner in which information is conveyed. The style attribute may comprise a set of stylistic parameters, a model of language characteristics that define the writing style, and/or the like. For instance, the style attribute may comprise features, such as formality level, sentiment, technical complexity, specific linguistic patterns, and/or the like. In some examples, the style attribute may be represented as a set of numerical scores for different stylistic dimensions, a categorical label indicating the overall style, a vector encoding various stylistic features, natural language text describing the various stylistic features, and/or the like.

In some examples, a datapoint attribute of a set of datapoint attributes 504 may comprise a context attribute that corresponds to a domain constraint that controls a source of the synthetic training datapoints 514. The context attribute, for example, may comprise an extracted data feature that corresponds to a domain constraint that controls a source of the synthetic training datapoint. A context attribute may capture one or more situational and/or environmental factors that provide additional meaning or relevance to the annotated training datapoints 404, representing the broader setting or circumstances in which the data exists. In some examples, the context attribute may be implemented as a set of metadata or contextual indicators that provide information about the source, purpose, or circumstances of the annotated training datapoints 404. This may include features such as document type, author role, intended audience, specific domain indicators, and/or the like. The context attribute, for example, may be represented as a structured set of key-value pairs, a categorical label indicating the overall context, natural language text that describes the overall context, and/or the like.

In some examples, a datapoint attribute of a set of datapoint attributes 504 may comprise a structure attribute that corresponds to a structural constraint that controls a structure of the synthetic training datapoints 514. The structure attribute, for example, may comprise an extracted data feature that corresponds to a structural constraint that controls a structure of the synthetic training datapoints 514. For example, a structure attribute may capture the organizational or formatting characteristics of the annotated training datapoint 404, representing how information is arranged or presented within them. The structure attribute may be typically implemented as a set of rules, templates, or patterns that define the observed structures of the annotated training datapoints 404. This may include specifications for sentence or paragraph structure, document layout, the arrangement of different components within the annotated training datapoints 404, and/or the like.

In some examples, a datapoint attribute of a set of datapoint attributes 504 may comprise a distribution attribute that corresponds to a label distribution constraint that controls a distribution of labels of the synthetic training datapoints 514. The distribution attribute, for example, may comprise an extracted data feature that corresponds to a label distribution constraint that controls a distribution of labels of the synthetic training datapoints 514. A distribution attribute, for example, may capture the statistical properties of how labeled entities and/or other annotated elements are distributed within annotated training datapoints 404. The distribution attribute, for example, may comprise a statistical model, a probability distribution that represents the relative frequencies and patterns of different labels or annotations within the data, and/or the like. This may be stored as a frequency table, a probability mass function, or a more complex model that captures dependencies between labels, and/or the like.

In some embodiments, at the second processing pipeline, the computing system 101 determines a labeled entity from an annotated training datapoint of the one or more annotated training datapoints 404. In some embodiments, a labeled entity is a portion of an annotated training datapoint that is labeled with an entity label that corresponds to a domain-specific dictionary 506. A labeled entity, for example, may comprise a specific word, phrase, or text span within a text-based annotated training datapoint, one or more bounding boxes within image-based annotated training datapoint, an audio snippet within an audio-based annotated training datapoint, and/or the like.

In some examples, a labeled entity may comprise a data structure that combines the content of an entity with its corresponding label, category, tag, and/or the like. For instance, the labeled entity may be stored as a tuple containing the entity content and/or entity label, a dictionary with keys for the entity content and/or entity label, and/or the like. By way of example, labeled entities may be represented using standardized formats, such as IOB (Inside-Outside-Beginning) tagging, stand-off annotations that separate the content from the annotation data, and/or the like.

The functionality of labeled entities within the annotated training datapoints 404 is to provide clear, annotated examples of entities within the context of domain-specific content. This allows NER models 408 to learn the patterns and contextual cues associated with different entity types. In the synthetic training framework 406, labeled entities from the original annotated training datapoints 404 may serve as the basis for creating new, synthetic training datapoints 514 that maintain the characteristics and distributions of the original data while improving the diversity of the original data, as described herein.

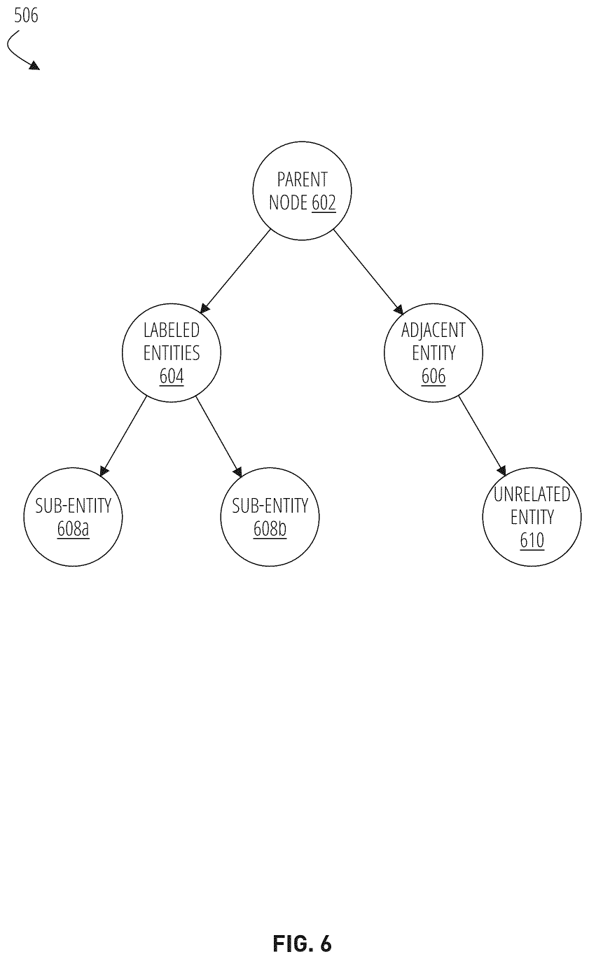

In some embodiments, the computing system 101 determines a set of related entities 508 from a domain-specific dictionary 506 based on the labeled entity. In some examples, the set of related entities 508 may comprise at least one of a first subset of sub-entities that is encapsulated by the labeled entity and/or (ii) a second subset of adjacent entities that is distinct from the labeled entity. By way of example, as described further with reference to FIG. 6, the domain-specific dictionary 506 may comprise a hierarchical dataset that defines a parent-child relationship between one or more defined entities within the hierarchical dataset. The set of related entities 508 may comprise a first subset of child entities and/or a second subset of sibling entities with respect to the labeled entity. For instance, up to each of the first subset of child entities may be connected to the labeled entity within the domain-specific dictionary 506 by a respective parent-child relationship and up to each of the second subset of sibling entities and the labeled entity may be connected to a common parent entity within the domain-specific dictionary 506.

In some embodiments, related entity, of the set of related entities 508, for a particular labeled entity within an annotated training datapoint 404 comprises to a defined entity from the domain-specific dictionary 506 that imparts an adjacent or more specific meaning than the labeled entity. Related entities 508, for example, may comprise semantically connected entities that are connected to a labeled entity either by sharing similar characteristics or by representing more specialized instances of the labeled entity. By way of example, the related entities 508 may comprise set of terms or concepts within a domain-specific dictionary 506 that may be directly or indirectly linked to the labeled entity through one or more defined relationships. The relationships may be stored in various data structures, such as hierarchical trees, graph databases, semantic networks, and/or the like, depending on the domain-specific dictionary 506.

In the context of the synthetic training framework 406, the set of related entities 508 for a labeled entity may be used to expand and diversify the range of entities included in the synthetic training datapoints 514. For example, while the datapoint attributes 504 bound the synthetic training datapoints 514 to original characteristics of the annotated training datapoints 404, the related entities 508 may expand the synthetic training datapoints 514 beyond the original characteristics of the annotated training datapoint 404 by introducing new entities that are related to but not present as labeled entities within the annotated training datapoints 404. In this manner, by identifying and incorporating related entities 508, the synthetic training framework 406 may generate synthetic training datapoints 514 that comprise semantically related content to create more varied and comprehensive training data to improve the NER model's 408 ability to accuracy across a broader range of entity variations and related concepts.

For example, the use of sub-entities may improve the granularity of NER model 408 outputs. A sub-entity, for example, may comprise a related entity that imparts a more specific meaning than a labeled entity present within an annotated training datapoint 404. For example, a sub-entity may represent a more granular and/or specialized instance of a given labeled entity. By way of example, a sub-entity may comprise a child term within a hierarchical relationship where the sub-entity is a subset or specific type of the labeled entity.

In the context of synthetic training framework 406, sub-entities may be used to introduce a more specific and/or varied entity instances into the synthetic training datapoints 514 in a controlled manner that increase diversity without introducing hallucinations. By incorporating sub-entities, for example, the synthetic training framework 406 may facilitate the generation of synthetic training datapoints 514 that comprise more specific, granular variations of a labeled entity. This process helps to create more nuanced and detailed training data that improves the performance of an NER model 408 with respect to different levels of specificity. In this manner, the sub-entities of the set of related entities 508 may enhance the granularity and specificity of entity recognition in synthetic data driven training technique.

In addition, or alternatively, the use of adjacent entities may improve the breadth of NER model 408 outputs. An adjacent entity, for example, may comprise a related entity that imparts an adjacent meaning with respect to a labeled entity. An adjacent entity, for instance, may comprise a synonym, a sibling term in a hierarchical or nested dictionary, and/or a similar concept that shares a semantic relationship with the labeled entity. An adjacent relationship, for example, may be defined within a domain-specific dictionary 506 using a linking relationship (e.g., an edge), one or more references (e.g., pointers), and/or the like. By way of example, adjacent entities may be represented as connected nodes in a graph database, as entries in a relational database, and/or the like, where the relationships between entities may be explicitly defined. Such relationships may be implemented using various data structures, such as adjacency lists or matrices, and/or the like. In the context of synthetic training framework 406, adjacent entities may be used to introduce a wider range of relevant entities into the synthetic training datapoints 514 to improve the robustness and generalization capabilities of the resulting NER model 408, as it is exposed to a more diverse set of entity variations during training.

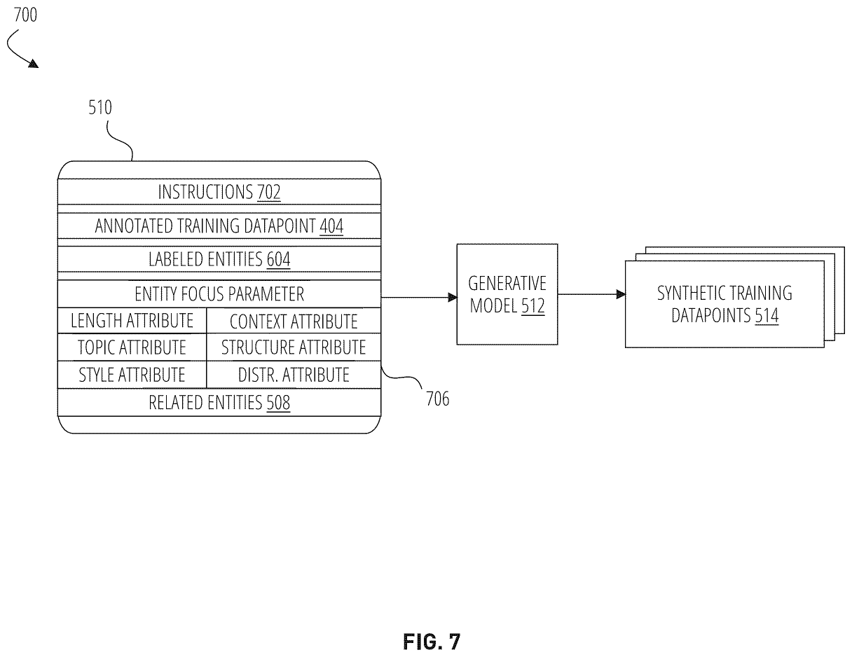

In some embodiments, the computing system 101 generates a generative prompt 510 based on the annotated training datapoint of the one or more annotated training datapoints 404, the set of related entities 508, and/or the datapoint attributes 504. For instance, as described further with reference to FIG. 7, the generative prompt 510 may comprise a set of instructions, one or more constraint fields respectively corresponding to one or more synthetic data constraints, one or more related entities 508, one or more of the annotated training datapoints 404, and/or the like.

In some embodiments, the computing system 101 generates, using a generative model 512, one or more synthetic training datapoints 514 based on the generative prompt 510. In some examples, the annotated training datapoint comprises a set of entity labels and the computing system 101 may generate a set of synthetic training datapoints 514 by generating a separate generative prompt 510 for up to each of the set of entity labels. The generative prompt 510 may be provided to the generative model 512 (e.g., the same or different generative model used to generate the datapoint attributes 504) to generate the synthetic training datapoints 514. After a set of iterations, the computing system 101 may generate an augmented training dataset for the NER model 408, which may be used to finetune the NER model 408 for a particular domain, as described herein.

FIG. 6 is an operational example of a domain-specific dictionary 506 in accordance with some embodiments of the present disclosure. As shown in the operational example, the domain-specific dictionary 506 may comprise a hierarchical dataset (e.g., Unified Medical Language System (UMLS) in a clinical domain) that defines parent-child relationships between one or more defined entities within the hierarchical dataset. Generally, the domain-specific dictionary 506 may comprise a domain dataset, lookup table, any other data structure that defines a set of entities that are specific to a particular domain. A domain-specific dictionary 506, for example, may serve as a comprehensive repository of terms, concepts, and/or relationships within a specialized field, such as medicine, finance, law, security, and/or the like. The domain-specific dictionary 506 may store entities and/or their relationships as natural language and/or as structure data that, in any format, may represent domain knowledge for enhancing the accuracy and relevance of content processing tasks, such as by defining relevant entities for NER applications.

In some examples, the domain-specific dictionary 506 may comprise a structured database system, such as a graph database, a relational database, a hybrid database that combines multiple data storage paradigms, and/or the like. In some examples, the choice of database may depend on factors, such as the complexity of relationships between entities, the volume of data, the specific query patterns, and/or the like.

In any form, the domain-specific dictionary 506 may enable the augmentation of labeled entities with related entities by defining relationships between a set of defined entities within a domain. For example, the domain-specific dictionary 506 may comprise an ontology, thesaurus, knowledge graphs, and/or the like that captures one or more complex semantic relationships between the defined entities. By way of example, the domain-specific dictionary 506 may comprise a hierarchical tree data structure that defines a set of parent-child between a set of defined entities. The parent-child edges, for example, may form a parent node 602, adjacent entities 606, sub-entities 608a-b, and/or unrelated entities 610 with respect to a labeled entities 604.

By way of example, a parent node 602 may correspond to an entity that is at least one hierarchical level above the labeled entities 604. For example, the labeled entities 604 may correspond to a more specific variation of the parent entity referenced by the parent node 602. In addition, or alternatively, an adjacent entity 606 may correspond to a node that is directly (or indirectly) connected to the same parent node 602 as the labeled entities 604. In this manner, the adjacent entity 606 may comprise a sibling to the labeled entities 604 that derives from a common parent entity. In some examples, a sub-entities 608a-b may correspond to a node that is directly (or indirectly) connected to the labeled entities 604 and located a lower hierarchical level than the labeled entities 604. In this manner, the sub-entities 608a-b may comprise children to the labeled entities 604 that correspond to a more specific variation of the labeled entities 604. An unrelated entity 610 may comprise any entity within the domain-specific dictionary 506 that is not a sibling, child, or parent to the labeled entities 604.

For example, a sub-entity may be implemented within a hierarchical structure of a domain-specific dictionary 506 as a child entity to the labeled entities 604. The hierarchical structure, for example, may be represented as a tree-like data structure, where each node represents an entity, and child nodes represent more specific sub-entities. In database systems, for example, the child relationship may be implemented using a recursive table structure, a nested set model, and/or the like. In addition, or alternatively, the relationships between the labeled entities 604 and/or sub-entities 608a-b may be defined using “is-a” or “type-of” relationships in semantic networks or ontology languages.

As another example, an adjacent entity may be implemented within a hierarchical structure of a domain-specific dictionary 506 as a sibling entity to the labeled entities 604. The hierarchical structure, for example, may be represented as a tree-like data structure, where each node represents an entity, and sibling nodes connected by a common parent node 602 represent adjacent entities. In database systems, for example, the sibling relationship may be implemented using a recursive table structure, a nested set model, and/or the like. In addition, or alternatively, the relationships between the labeled entities 604 and/or adjacent entity 606 may be defined using “is-similar-to” relationships in semantic networks or ontology languages.

FIG. 7 is an operational example 700 of a generative prompt 510 for a synthetic training datapoints 514 in accordance with some embodiments of the present disclosure. As shown in the operational example, the generative prompt 510 may comprise a set of instructions 702, one or more annotated training datapoints 404, one or more constraint fields 706, one or more related entities 508, and/or the like. By way of example, the generative prompt 510 may comprise an annotated training datapoint 404, the instructions 702, a set of constraint fields 706 respectively corresponding to a set of synthetic data constraints, and a set of related entities 508 for up to each of one or more labeled entities within the annotated training datapoint 404. In some examples, up to each generative prompt 510 may comprise an entity focusing parameter that focuses a generative model 512 on one of a set of labeled entities 604 within the annotated training datapoint 404. In this manner, a separate generative prompt 510 may be generated for up to each labeled entities 604 within the annotated training datapoint 404 to sequentially (and/or in parallel) generate a set of synthetic training datapoints 514 from a single annotated training datapoint 404.

In some embodiments, the generative prompt 510 comprise a synthetic data generation prompt that is augmented, using the instruction finetuning operations of the present disclosure, to create realistic annotated data for training a machine learning model. A generative prompt 510, for example, may provide a structured input to a generative model 512 to guide the model to produce synthetic training datapoints 514 that closely resemble real-world data while incorporating controlled variations based on entity distributions within an original dataset. By carefully designing the generative prompt 510, a computing system 101 may control various aspects of the generated synthetic training datapoints 514, such as the distribution of entity types, the linguistic style, the overall structure, and/or the like, to generate realistic datapoints that introduce variation into a machine learning model training process. In some examples, the generative prompt 510 may comprise a single prompt, chain-of-thought prompts that guide the model through a step-by-step reasoning process, iterative prompting techniques that refine the generated output through multiple passes, and/or the like. Additionally, or alternatively, the generative prompt 510 may be dynamically adjusted based on feedback from the quality assessment of generated samples, creating a closed-loop system for continuous improvement of synthetic data quality.

In some embodiments, the generative prompt 510 comprises a prompt template that is constructed dynamically based on the datapoint attributes 504 and/or related entities 508 generated from an annotated training datapoints 404. For example, the generative prompt 510 may comprise a static template portion that may define a set of instructions 702 for the generative model 512 that may be supplemented by a set of datapoint-or entity-level constraint fields 706.

The set of instructions 702, for example, may comprise a set of synthetic data generation commands, requests, and/or the like that may guide a generative model 512 through a synthetic data generation process in accordance with a set of dynamically defined constraints. By way of example, the instructions 702 may comprise explicit directives to the generative model 512 on how to construct synthetic training datapoints 514 that meet or exceed specific criteria. For instance, the set of directives may comprise a first instruction that “Your task is to create a synthetic dataset for NER by editing and paraphrasing the sentence: [annotated training datapoint].” In addition, or alternatively, the directives may comprise a second instruction to “Generate up to 20 diverse sentences, images, or audio from the following descriptions: [constraint fields 706],” and/or the like. In such a case, the instructions 702 may comprise static directives that may reference dynamic parameters within the generative prompt 510 to guide the generative model 512 in adhering to domain-specific constraints, such as maintaining proper entity relationships, using appropriate terminology, and/or the like. By carefully tailoring the constraint fields 706 of the generative prompt 510 to a particular annotated training datapoint 404 (and/or an entity focus parameter thereof), the computing system 101 may generate synthetic training datapoints 514 that contain the correct entities, while mimicking the nuances and/or variability of real-world text in the target domain.

In some embodiments, the constraint fields 706 of the generative prompt 510 comprise dynamic portions of the generative prompt 510 that may be tailored to an annotated training datapoint 404 and/or a labeled entity of the annotated training datapoint 404. The constraint fields 706, for example, may be implemented as structured data elements within the generative prompt 510. These fields may be represented as key-value pairs, JSON objects, specially formatted text strings, and/or the like that the generative model 512 may interpret to guide its generative process.

For example, a first constraint field of the constraint fields 706 may comprise an entity focus parameter. The entity focus parameter may identify one of the set of labeled entities 604 within the annotated training datapoint 404 as a target for an iteration of the synthetic data generation process. In this manner, the generative prompt 510 may generated at an entity level to reduce variations between the synthetic training datapoints 514 and an annotated training datapoint 404, while introducing incremental variations at a single entity level. In addition, or alternatively, the entity focus parameter may identify one or more or all of the set of labeled entities 604 within the annotated training datapoint 404 to provide multiple targets are each iteration of the synthetic data generation process.

In addition, or alternatively, one or more of the constraint fields 706 may be specific to one or more synthetic data constraints. By way of example, the constraint fields 706 may comprise at least one of a length attribute field that may be dynamically populated with a length attribute, a topic attribute field that may be dynamically populated with a topic attribute, a style attribute field that may be dynamically populated with a style attribute, a context attribute field that may be dynamically populated with a context attribute, a structure attribute field that may be dynamically populated with a structure attribute, a distribution attribute field that may be dynamically populated with a distribution attribute, and/or the like. In this manner, the constraint fields of the generative prompt 510 may shape the characteristics of the synthetic training datapoints 514 by providing fine-grained control over various aspects of the output, such as their entity types and their frequency of occurrence, the output length and complexity, its style and tone, domain-specific contextual information, structural elements of the output content (e.g., paragraph organization, use of headings), among others. By manipulating these constraint fields, the computing system 101 may generate diverse sets of synthetic data that maintain consistency with the target domain while exploring different variations and edge cases.

In addition, or alternatively, one or more of the constraint fields 706 may comprise a set of related entities 508 for up to each of the labeled entities 604 within the annotated training datapoint 404. By way of example, the set of related entities 508 may comprise one or more related entities 508 for a labeled entity identified by an entity focus parameter. In addition, or alternatively, the related entities 508 may comprise a subset of related entities 508 for each of the labeled entities 604 within the annotated training datapoint 404.

In this manner, the constraint fields 706 of the generative prompt 510 may enable the automated creation of synthetic datasets that are tailored to specific training objectives and that address known biases or gaps in existing training data. For example, constraint fields 706 may be used to generate examples that focus on rare entity types or uncommon linguistic constructions, helping to improve the robustness of a trained NER model.

In some embodiments, a synthetic training datapoint of the synthetic training datapoints 514 comprises a synthetic sample that is generated, using the generative prompt 510, based on a subset of annotated training datapoints 404, a single annotated training datapoint 404, and/or a labeled entity within one or more annotated training datapoints 404. The synthetic training datapoint may comprise an artificially created examples designed to augment and diversify the training data for training an NER model, particularly in domains where annotated data may be scarce or expensive to obtain. In some examples, a synthetic training datapoint may be generated by feeding the generative prompt 510 into the generative model 512 at a subset of annotated training datapoints 404 level, a single annotated training datapoint 404 level, and/or a labeled entity level. At each iteration, the generative model 512 may produce one or more synthetic training datapoints 514 that mimic the structure, style, and content of subset of annotated training datapoints 404 while incorporating variations and new entity combinations at a level of specificity designated for the particular iteration.

In this manner, the synthetic training datapoints 514 may serve as a resource for enhancing the performance and generalization capabilities of NER models. By generating a large number of diverse, yet domain-relevant examples, the synthetic training framework 406 of the present disclosure may expose a downstream NER model to a wider range of entity contexts and relationships than may be available in traditional datasets. In addition, or alternatively, the synthetic training datapoints 514 may balance entity distributions in a training dataset, introducing controlled variations in entity contexts, generate examples of rare or novel entity combinations, simulate different writing styles or document types within the domain, among other performance enhancement that may create more robust NER models that may handle a broader range of inputs and generalize better to unseen data in real-world applications.

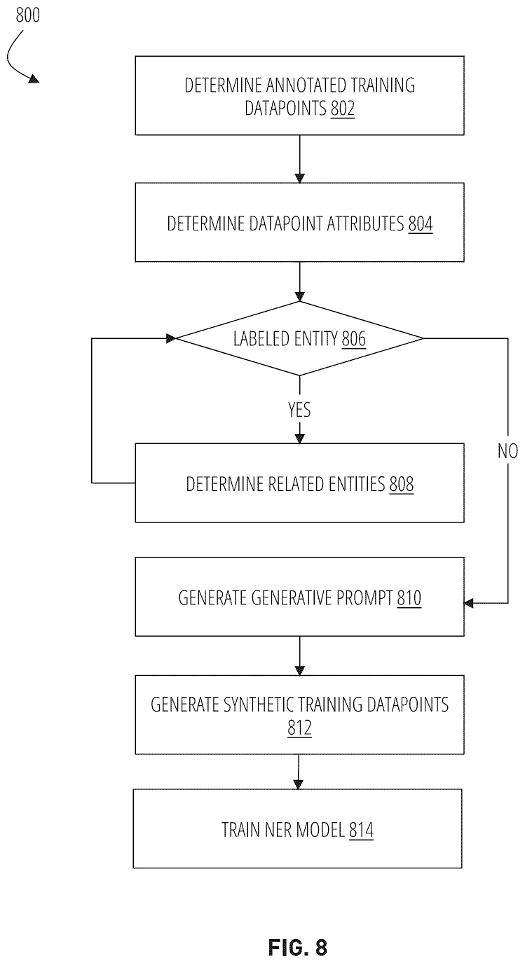

FIG. 8 is a flowchart diagram of machine learning model training process 800 in accordance with some embodiments of the present disclosure. The flowchart diagram depicts a synthetic data driven training approach that may be integrate an automated synthetic training framework 406 within a training process to improve the performance of a downstream model. The process 800 may be implemented by one or more computing devices, entities, and/or systems described herein. For example, via the various steps/operations of the process 800, the computing system 101 may extract a set of collective (e.g., datapoint attributes) and individual (e.g., related entities) data constraints from a limited set of annotated training datapoints that may serve as constraints for guiding a synthetic data generation process. By doing so, the process 800 may improve computer functionality by improving the accuracy, applicability, and scope of training for a machine learning task, which, in turn, may improve the performance of downstream machine learning models, including those that traditionally suffer from a lack of training data.

FIG. 8 illustrates an example process 800 for explanatory purposes. Although the example process 800 depicts a particular sequence of steps/operations, the sequence may be altered without departing from the scope of the present disclosure. For example, some of the steps/operations depicted may be performed in parallel or in a different sequence that does not materially impact the function of the process 800. In other examples, different components of an example device or system that implements the process 800 may perform functions at substantially the same time or in a specific sequence.

In some embodiments, the process 800 comprises, at operation 802, determining annotated training datapoints. For example, the computing system 101 may determine an annotated training datapoint from a domain-specific training corpus. The domain-specific training corpus, for example, may be annotated for a task-specific NER model.

In some examples, the annotated training datapoint may be one of a subset of annotated training datapoints determined from the domain-specific training corpus. For instance, the subset of annotated training datapoints may be determined based on a relative label distribution between each annotated training datapoint within the subset of annotated training datapoints and the domain-specific training corpus.

In some embodiments, the process 800 comprises, at operation 804, determining datapoint attributes. For example, the computing system 101 may generate an attribute extraction prompt based on a set of synthetic data constraints and the subset of annotated training datapoints. In some examples, the attribute extraction prompt comprises a set of extraction instructions for up to each of the set of synthetic data constraints. The computing system 101 may generate, using a generative model, a set of datapoint attributes respectively corresponding to the set of synthetic data constraints based on the attribute extraction prompt.

By way of example, a datapoint attribute of the set of datapoint attributes may comprise at least one of a length attribute that corresponds to a data length constraint that controls a length of a synthetic training datapoint of the set of synthetic training datapoints, a topic attribute that corresponds to a topic constraint that controls a subject category of the synthetic training datapoint, a style attribute that corresponds to a tone constraint that controls a tone of the synthetic training datapoint, a context attribute that corresponds to a domain constraint that controls a source of the synthetic training datapoint, a structure attribute that corresponds to a structural constraint that controls a structure of the synthetic training datapoint, and/or a distribution attribute that corresponds to a label distribution constraint that controls a distribution of labels of the synthetic training datapoint.

In some embodiments, the process 800 comprises, at operation 806, determining whether an unprocessed labeled entity exists for an annotated training datapoint. For example, the computing system 101 may determine whether an unprocessed labeled entity exists for an annotated training datapoint. In the event of an unprocessed labeled entity, the process 800 may proceed to operation 808. Otherwise, the process 800 may proceed to operation 810.

In some embodiments, the process 800 comprises, at operation 808, determining related entities for a labeled entity. For example, the computing system 101 may determine a labeled entity from an annotated training datapoint determined from a domain-specific training corpus. The computing system 101 may determine a set of related entities from a domain-specific dictionary based on the labeled entity. In some examples, the set of related entities may comprise at least one of a first subset of sub-entities that is encapsulated by the labeled entity and/or (ii) a second subset of adjacent entities that is distinct from the labeled entity. By way of example, the domain-specific dictionary may comprise a hierarchical dataset that defines a parent-child relationship between one or more defined entities within the hierarchical dataset. The set of related entities may comprise a first subset of child entities and/or a second subset of sibling entities with respect to the labeled entity. For instance, up to each of the first subset of child entities may be connected to the labeled entity within the domain-specific dictionary by a respective parent-child relationship and up to each of the second subset of sibling entities and the labeled entity may be connected to a common parent entity within the domain-specific dictionary.

In some embodiments, the process 800 comprises, at operation 810, generating a generative prompt. For example, the computing system 101 may generate a generative prompt based on the annotated training datapoint and the set of related entities. In addition, or alternatively, the computing system 101 may generate the generative prompt based on the set of datapoint attributes. By way of example, the generative prompt may comprise a set of instructions, a set of constraint fields respectively corresponding to the set of synthetic data constraints, the set of related entities, the annotated training datapoint, and/or the like.

In some embodiments, the process 800 comprises, at operation 812, generating synthetic training datapoints. For example, the computing system 101 may generate, using a generative model, a set of synthetic training datapoints based on the generative prompt. In some examples, the annotated training datapoint comprises set of entity labels and the computing system 101 may generate a set of synthetic training datapoints by generating a separate generative prompt for up to each of the set of entity labels.

In some embodiments, the process 800 comprises, at operation 814, training an NER model. For example, the computing system 101 may train a task-specific NER model using the set of synthetic training datapoints.

Some techniques of the present disclosure enable the generation of action outputs that may be performed to initiate one or more real world actions to achieve real-world effects. The techniques of the present disclosure may be used, applied, and/or otherwise leveraged generate synthetic data and/or code predictions in various domains. In some examples, the synthetic data, and/or code predictions based thereon, of the present disclosure may trigger action outputs (e.g., through control instructions) to automate a computer, a robotic device, a medical diagnostic and/or injection device, and/or the like. The action outputs may control various aspects of a client device, such as the display, transmission, and/or the like of data reflective of an alert, and/or the like. The alert may be automatically communicated to a user and/or may be used to initiate a security protocol (e.g., locking a computer), a robotic action (e.g., performing an automated screening process), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.

Example 1. A computer-implemented method comprising determining, by one or more processors, a labeled entity from an annotated training datapoint determined from a domain-specific training corpus, wherein the domain-specific training corpus is annotated for a task-specific named entity recognition (NER) model; determining, by the one or more processors, a set of related entities from a domain-specific dictionary based on the labeled entity; generating, by the one or more processors, a generative prompt based on the annotated training datapoint and the set of related entities; generating, by the one or more processors and using a generative model, a set of synthetic training datapoints based on the generative prompt; and training, by the one or more processors, the task-specific NER model using the set of synthetic training datapoints.

Example 2. The computer-implemented method of example 1, wherein the annotated training datapoint is one of a subset of annotated training datapoints determined from the domain-specific training corpus, and the computer-implemented method further comprises generating an attribute extraction prompt based on a set of synthetic data constraints and the subset of annotated training datapoints; generating, using the generative model, a set of datapoint attributes respectively corresponding to the set of synthetic data constraints based on the attribute extraction prompt; and generating the generative prompt based on the set of datapoint attributes.

Example 3. The computer-implemented method of example 2, wherein the subset of annotated training datapoints is determined based on a relative label distribution between each annotated training datapoint within the subset of annotated training datapoints and the domain-specific training corpus.

Example 4. The computer-implemented method of any of examples 2 through 3, wherein the attribute extraction prompt comprises a set of extraction instructions for each of the set of synthetic data constraints.

Example 5. The computer-implemented method of any of examples 2 through 4, wherein the generative prompt comprises a set of instructions, a set of constraint fields respectively corresponding to the set of synthetic data constraints, the set of related entities, and the annotated training datapoint.

Example 6. The computer-implemented method of any of examples 2 through 5, wherein a datapoint attribute of the set of datapoint attributes comprises at least one of: (i) a length attribute that corresponds to a data length constraint that controls a length of a synthetic training datapoint of the set of synthetic training datapoints, (ii) a topic attribute that corresponds to a topic constraint that controls a subject category of the synthetic training datapoint, (iii) a style attribute that corresponds to a tone constraint that controls a tone of the synthetic training datapoint, (iv) a context attribute that corresponds to a domain constraint that controls a source of the synthetic training datapoint, (v) a structure attribute that corresponds to a structural constraint that controls a structure of the synthetic training datapoint, or (vi) a distribution attribute that corresponds to a label distribution constraint that controls a distribution of labels of the synthetic training datapoint.

Example 7. The computer-implemented method of any of the preceding examples, wherein the set of related entities comprises at least one of: (i) a first subset of sub-entities that is encapsulated by the labeled entity or (ii) a second subset of adjacent entities that is distinct from the labeled entity.

Example 8. The computer-implemented method of any of the preceding examples, wherein the domain-specific dictionary comprises a hierarchical dataset that defines a parent-child relationship between one or more defined entities within the hierarchical dataset, and the set of related entities comprises (i) a first subset of child entities and (ii) a second subset of sibling entities with respect to the labeled entity.

Example 9. The computer-implemented method of example 8, wherein (i) each of the first subset of child entities is connected to the labeled entity within the domain-specific dictionary by a respective parent-child relationship and (ii) each of the second subset of sibling entities and the labeled entity are connected to a common parent entity within the domain-specific dictionary.

Example 10. The computer-implemented method of any of the preceding examples, wherein the annotated training datapoint comprises set of entity labels and generating the set of synthetic training datapoints comprises generating a separate generative prompt for each of the set of entity labels.

Example 11. A system comprising one or more processors; and one or more memories storing processor-executable instructions that, when executed by the one or more processors, cause the one or more processors to perform operations comprising determining a labeled entity from an annotated training datapoint determined from a domain-specific training corpus, wherein the domain-specific training corpus is annotated for a task-specific named entity recognition (NER) model; determining a set of related entities from a domain-specific dictionary based on the labeled entity; generating a generative prompt based on the annotated training datapoint and the set of related entities; generating, using a generative model, a set of synthetic training datapoints based on the generative prompt; and training the task-specific NER model using the set of synthetic training datapoints.

Example 12. The system of example 11, wherein the annotated training datapoint is one of a subset of annotated training datapoints determined from the domain-specific training corpus, and the operations further comprise generating an attribute extraction prompt based on a set of synthetic data constraints and the subset of annotated training datapoints; generating, using the generative model, a set of datapoint attributes respectively corresponding to the set of synthetic data constraints based on the attribute extraction prompt; and generating the generative prompt based on the set of datapoint attributes.

Example 13. The system of example 12, wherein the subset of annotated training datapoints is determined based on a relative label distribution between each annotated training datapoint within the subset of annotated training datapoints and the domain-specific training corpus.

Example 14. The system of any of examples 12 through 13, wherein the attribute extraction prompt comprises a set of extraction instructions for each of the set of synthetic data constraints.

Example 15. The system of any of examples 12 through 14, wherein the generative prompt comprises a set of instructions, a set of constraint fields respectively corresponding to the set of synthetic data constraints, the set of related entities, and the annotated training datapoint.

Example 16. The system of any of examples 12 through 15, wherein a datapoint attribute of the set of datapoint attributes comprises at least one of (i) a length attribute that corresponds to a data length constraint that controls a length of a synthetic training datapoint of the set of synthetic training datapoints, (ii) a topic attribute that corresponds to a topic constraint that controls a subject category of the synthetic training datapoint, (iii) a style attribute that corresponds to a tone constraint that controls a tone of the synthetic training datapoint, (iv) a context attribute that corresponds to a domain constraint that controls a source of the synthetic training datapoint, (v) a structure attribute that corresponds to a structural constraint that controls a structure of the synthetic training datapoint, or (vi) a distribution attribute that corresponds to a label distribution constraint that controls a distribution of labels of the synthetic training datapoint.

Example 17. The system of any of examples 12 through 16, wherein the set of related entities comprises at least one of: (i) a first subset of sub-entities that is encapsulated by the labeled entity or (ii) a second subset of adjacent entities that is distinct from the labeled entity.

Example 18. One or more non-transitory computer-readable media storing processor-executable instructions that, when executed by one or more processors, cause the one or more processors to perform operations comprising determining a labeled entity from an annotated training datapoint determined from a domain-specific training corpus, wherein the domain-specific training corpus is annotated for a task-specific named entity recognition (NER) model; determining a set of related entities from a domain-specific dictionary based on the labeled entity; generating a generative prompt based on the annotated training datapoint and the set of related entities; generating, using a generative model, a set of synthetic training datapoints based on the generative prompt; and training the task-specific NER model using the set of synthetic training datapoints.

Example 19. The one or more non-transitory computer-readable media of example 18, wherein the domain-specific dictionary comprises a hierarchical dataset that defines a parent-child relationship between one or more defined entities within the hierarchical dataset, and the set of related entities comprises (i) a first subset of child entities and (ii) a second subset of sibling entities with respect to the labeled entity.

Example 20. The one or more non-transitory computer-readable media of example 19, wherein (i) each of the first subset of child entities is connected to the labeled entity within the domain-specific dictionary by a respective parent-child relationship and (ii) each of the second subset of sibling entities and the labeled entity are connected to a common parent entity within the domain-specific dictionary.

Example 21. The computer-implemented method of example 1, wherein the method further comprises training the task-specific NER model.

Example 22. The computer-implemented method of example 21, wherein the training is performed by the one or more processors.

Example 23. The computer-implemented method of example 21, wherein the one or more processors are comprised in a first computing entity; and the training is performed by one or more other processors comprised in a second computing entity.

Example 24. The computing system of example 11, wherein the one or more processors are further configured to train the task-specific NER model.

Example 25. The computing system of example 24, wherein the one or more processors are comprised in a first computing entity; and the task-specific NER model is trained by one or more other processors comprised in a second computing entity.

Example 26. The one or more non-transitory computer-readable storage media of example 18, wherein the instructions further cause the one or more processors to train the task-specific NER model.

Example 27. The one or more non-transitory computer-readable storage media of example 26, wherein the one or more processors are comprised in a first computing entity; and the task-specific NER model is trained by one or more other processors comprised in a second computing entity.

What is claimed is:

1. A computer-implemented method comprising:
determining, by one or more processors, a labeled entity from an annotated training datapoint determined from a domain-specific training corpus, wherein the domain-specific training corpus is annotated for a task-specific named entity recognition (NER) model;
determining, by the one or more processors, a set of related entities from a domain-specific dictionary based on the labeled entity;
generating, by the one or more processors, a generative prompt based on the annotated training datapoint and the set of related entities;
generating, by the one or more processors and using a generative model, a set of synthetic training datapoints based on the generative prompt; and
training, by the one or more processors, the task-specific NER model using the set of synthetic training datapoints.

2. The computer-implemented method of claim 1, wherein the annotated training datapoint is one of a subset of annotated training datapoints determined from the domain-specific training corpus, and the computer-implemented method further comprises:
generating an attribute extraction prompt based on a set of synthetic data constraints and the subset of annotated training datapoints;
generating, using the generative model, a set of datapoint attributes respectively corresponding to the set of synthetic data constraints based on the attribute extraction prompt; and
generating the generative prompt based on the set of datapoint attributes.

3. The computer-implemented method of claim 2, wherein the subset of annotated training datapoints is determined based on a relative label distribution between each annotated training datapoint within the subset of annotated training datapoints and the domain-specific training corpus.

4. The computer-implemented method of claim 2, wherein the attribute extraction prompt comprises a set of extraction instructions for each of the set of synthetic data constraints.

5. The computer-implemented method of claim 2, wherein the generative prompt comprises a set of instructions, a set of constraint fields respectively corresponding to the set of synthetic data constraints, the set of related entities, and the annotated training datapoint.

6. The computer-implemented method of claim 2, wherein a datapoint attribute of the set of datapoint attributes comprises at least one of:
(i) a length attribute that corresponds to a data length constraint that controls a length of a synthetic training datapoint of the set of synthetic training datapoints,
(ii) a topic attribute that corresponds to a topic constraint that controls a subject category of the synthetic training datapoint,
(iii) a style attribute that corresponds to a tone constraint that controls a tone of the synthetic training datapoint,
(iv) a context attribute that corresponds to a domain constraint that controls a source of the synthetic training datapoint,
(v) a structure attribute that corresponds to a structural constraint that controls a structure of the synthetic training datapoint, or
(vi) a distribution attribute that corresponds to a label distribution constraint that controls a distribution of labels of the synthetic training datapoint.

7. The computer-implemented method of claim 1, wherein the set of related entities comprises at least one of: (i) a first subset of sub-entities that is encapsulated by the labeled entity or (ii) a second subset of adjacent entities that is distinct from the labeled entity.

8. The computer-implemented method of claim 1, wherein the domain-specific dictionary comprises a hierarchical dataset that defines a parent-child relationship between one or more defined entities within the hierarchical dataset, and the set of related entities comprises (i) a first subset of child entities and (ii) a second subset of sibling entities with respect to the labeled entity.

9. The computer-implemented method of claim 8, wherein (i) each of the first subset of child entities is connected to the labeled entity within the domain-specific dictionary by a respective parent-child relationship and (ii) each of the second subset of sibling entities and the labeled entity are connected to a common parent entity within the domain-specific dictionary.

10. The computer-implemented method of claim 1, wherein the annotated training datapoint comprises set of entity labels and generating the set of synthetic training datapoints comprises generating a separate generative prompt for each of the set of entity labels.

11. A system comprising:
one or more processors; and
one or more memories storing processor-executable instructions that, when executed by the one or more processors, cause the one or more processors to perform operations comprising:
determining a labeled entity from an annotated training datapoint determined from a domain-specific training corpus, wherein the domain-specific training corpus is annotated for a task-specific named entity recognition (NER) model;
determining a set of related entities from a domain-specific dictionary based on the labeled entity;
generating a generative prompt based on the annotated training datapoint and the set of related entities;
generating, using a generative model, a set of synthetic training datapoints based on the generative prompt; and
training the task-specific NER model using the set of synthetic training datapoints.

12. The system of claim 11, wherein the annotated training datapoint is one of a subset of annotated training datapoints determined from the domain-specific training corpus, and the operations further comprise:
generating an attribute extraction prompt based on a set of synthetic data constraints and the subset of annotated training datapoints;
generating, using the generative model, a set of datapoint attributes respectively corresponding to the set of synthetic data constraints based on the attribute extraction prompt; and
generating the generative prompt based on the set of datapoint attributes.

13. The system of claim 12, wherein the subset of annotated training datapoints is determined based on a relative label distribution between each annotated training datapoint within the subset of annotated training datapoints and the domain-specific training corpus.

14. The system of claim 12, wherein the attribute extraction prompt comprises a set of extraction instructions for each of the set of synthetic data constraints.

15. The system of claim 12, wherein the generative prompt comprises a set of instructions, a set of constraint fields respectively corresponding to the set of synthetic data constraints, the set of related entities, and the annotated training datapoint.

16. The system of claim 12, wherein a datapoint attribute of the set of datapoint attributes comprises at least one of:
(i) a length attribute that corresponds to a data length constraint that controls a length of a synthetic training datapoint of the set of synthetic training datapoints,
(ii) a topic attribute that corresponds to a topic constraint that controls a subject category of the synthetic training datapoint,
(iii) a style attribute that corresponds to a tone constraint that controls a tone of the synthetic training datapoint,
(iv) a context attribute that corresponds to a domain constraint that controls a source of the synthetic training datapoint,
(v) a structure attribute that corresponds to a structural constraint that controls a structure of the synthetic training datapoint, or
(vi) a distribution attribute that corresponds to a label distribution constraint that controls a distribution of labels of the synthetic training datapoint.

17. The system of claim 11, wherein the set of related entities comprises at least one of: (i) a first subset of sub-entities that is encapsulated by the labeled entity or (ii) a second subset of adjacent entities that is distinct from the labeled entity.

18. One or more non-transitory computer-readable media storing processor-executable instructions that, when executed by one or more processors, cause the one or more processors to perform operations comprising:
determining a labeled entity from an annotated training datapoint determined from a domain-specific training corpus, wherein the domain-specific training corpus is annotated for a task-specific named entity recognition (NER) model;
determining a set of related entities from a domain-specific dictionary based on the labeled entity;
generating a generative prompt based on the annotated training datapoint and the set of related entities;
generating, using a generative model, a set of synthetic training datapoints based on the generative prompt; and
training the task-specific NER model using the set of synthetic training datapoints.

19. The one or more non-transitory computer-readable media of claim 18, wherein the domain-specific dictionary comprises a hierarchical dataset that defines a parent-child relationship between one or more defined entities within the hierarchical dataset, and the set of related entities comprises (i) a first subset of child entities and (ii) a second subset of sibling entities with respect to the labeled entity.

20. The one or more non-transitory computer-readable media of claim 19, wherein (i) each of the first subset of child entities is connected to the labeled entity within the domain-specific dictionary by a respective parent-child relationship and (ii) each of the second subset of sibling entities and the labeled entity are connected to a common parent entity within the domain-specific dictionary.
